(19) United States
(12) Patent Application Publication
(10) Pub. No.: US 2008/0279179 A1
(43) Pub. Date: Nov. 13, 2008

(54) Ethernet Based Network for Distributing Ip and Non-Ip Signals

(75) Inventor: Keith Baker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,552

(22) PCT Filed: Jul. 12, 2004
(86) PCT No.: PCT/IB04/52693

§ 371 Date: Jun. 16, 2006

(30) Foreign Application Priority Data
Dec. 22, 2003 (EP) 03104915.8

(51) Int. Cl. H04L 29/06

(52) U.S. Cl. 370/359; 370/465

(57) ABSTRACT

The present invention relates to a system and a method for distributing both IP signals and non-IP signals in an Ethernet based network, wherein the Ethernet based network comprises UTP cabling comprising a number of wires, the method comprises distributing said non-IP signals through a signal path based on wires comprised in said cabling and not being used for distributing said IP signals. The invention further relates to a gateway, a router and a switch for receiving both IP signals and non-IP signals, processing said IP signals and non-IP signals and transmitting said processed IP signals and non-IP signals via the Ethernet based network.

The present invention relates to a method for distributing both IP signals and non-IP signals in an Ethernet based network. The invention also relates to a communication system for distributing both IP signals and non-IP signals in an Ethernet based network. The invention further relates to a gateway, a router and a switch adapted to be used in a communication system for distributing both IP signals and non-IP signals in an Ethernet based network.

Currently home networks are a heterogeneous set of wired and wireless networks using both digital and analogue modulation techniques to transfer the data using a wide variety of protocols. The emergence of IP based protocols for industrial and office networks has given some experts the expectation that IP or Ethernet based protocols will dominate in the home. However, unlike office networks, future home networks are not professionally designed but evolve according to the household needs. Besides Ethernet networks, the household typically also comprises traditional networks of products based on e.g. phones (POTS/DECT) and TVs (UHF/VHF). Users are accustomed to these networks, and it will be difficult to move them amass, in all segments, to new technology such as Ethernet IP.

All the different types of networks in the household based on e.g. phone systems, video systems and audio systems introduce a lot of wires in the building, which can be both very messy to look at and expensive and complicated to maintain.

Different approaches exist where the different networks are integrated in one network.

In U.S. Pat. No. 6,157,810 a system and a method is described for transmitting a radio frequency (RF) signal in a RF bandwidth over a low bandwidth medium e.g. Category 5 UTP cabling. It is not described how the number of wires being the result of different systems can be minimized. The system and method make it possible to intercept wireless RF signals, the intercepted RF signals are then distributed via a low bandwidth medium to a destination, and at the destination the RF signals are again transmitted wirelessly.

It is therefore an object of the invention to obtain a solution to the above-mentioned problems and minimizing the number of household wiring networks.

This is obtained by a method for distributing both IP signals and non-IP signals in an Ethernet based network, wherein the Ethernet based network comprises UTP cabling comprising a number of wires, the method comprises distributing said non-IP signals through a signal path based on wires comprised in said cabling and not being used for distributing said IP signals.

Thereby, an Ethernet network already present in many buildings can also be used for distributing other types of signals both analogically and digitally such as USB, audio, video, etc. Since Ethernet based networks comprising UTP cabling are already widely used and also will be in the future, using these networks for distributing non-IP signals is an easy way of avoiding to add further networks to be used for distributing the non-IP signals.

In a specific embodiment an adaptation is performed on either said signal path or said non-IP signals before distributing said non-IP signals on wires comprised in said cabling. This is necessary since the UTP cabling is designed to handle a specific category of signals, and when the cabling should handle another category an adaptation might be necessary e.g. by managing the bandwidth of the signals, as necessary to avoid quality loss.

In an embodiment the adaptation performed on said signal path comprises adapting the impedance of said signal path. This is, since the impedance of the transmission medium of twisted pairs in UTP cabling is 100 ohm, accurately manufactured in the cable. Other signal types need a medium having a different impedance in order to be distributed properly.

In another embodiment, the adaptation is achieved by active adaptation of the signal propagation by control of the driver strength. This method of adaptation is based on an explicit measurement of the characteristics of the UTP cabling and connectors using an industrial technique for telecommunication systems, but not applied in a consumer environment, i.e. Time Domain Reflectometry (TDR). This test is proven as an easy and robust way to perform adaptation of signal characteristics to signal paths.

The invention further relates to a communication system for distributing both IP signals and non-IP signals in an Ethernet based network, wherein the communication system comprises UTP cabling comprising a number of wires, where the wires comprised in said cabling, which are not being used for IP signals are adapted for distributing said non-IP signals.

Thereby, an Ethernet communication system already present in many buildings can also be used for distributing other types of signals both analogically and digitally such as USB, audio, video, etc. Since Ethernet based networks comprising UTP cabling are already widely used and also will be in the future, using these networks for distributing non-IP signals is an easy way of avoiding to add further networks to be used for distributing the non-IP signals.

In a specific embodiment the system comprises a gateway, said gateway being adapted for:

receiving non-IP signals,

performing an adaptation on either said signal path or said non-IP signals before distributing said non-IP signals on wires comprised in said cabling,

transmitting said processed non-IP signals via the Ethernet based network.

By handling the signal in an adapted gateway, the IP signals and the non-IP signals are handled at the entrance to the network, whereby all transcoding and security issues can be performed on IP and non-IP signals protected by a firewall. These include security checks of content (verify certificates and check flags), and the addition by transcoding of watermarks and related security devices in the content or related metadata, for conversion to analogue protocols. Such security processes to protect digital content as it is transcoded at the gateway can be monitored and checked by the verification process of third parties to ensure the copyright and author-rights have not been violated.

In an embodiment, the system comprises a router, said router being adapted for routing the non-IP signals, enabling the non-IP signals to be broadcasted to all end points in the Ethernet network. The adaptation of the router could comprise a multiplexed, or an emitter-follower amplifier, or similar implementation in CMOS technology that allows a signal to be duplicated at the output ports of the router according to the selected input port signal.

In an embodiment, the system comprises a switch, said switch being adapted for:

transmitting said non-IP signals,

switching between said non-IP signals and said IP signals.

The invention further relates to a gateway, a router, and a switch adapted to be used in a communication system according to the present invention.

In the following, preferred embodiments of the invention will be described referring to the figures, where

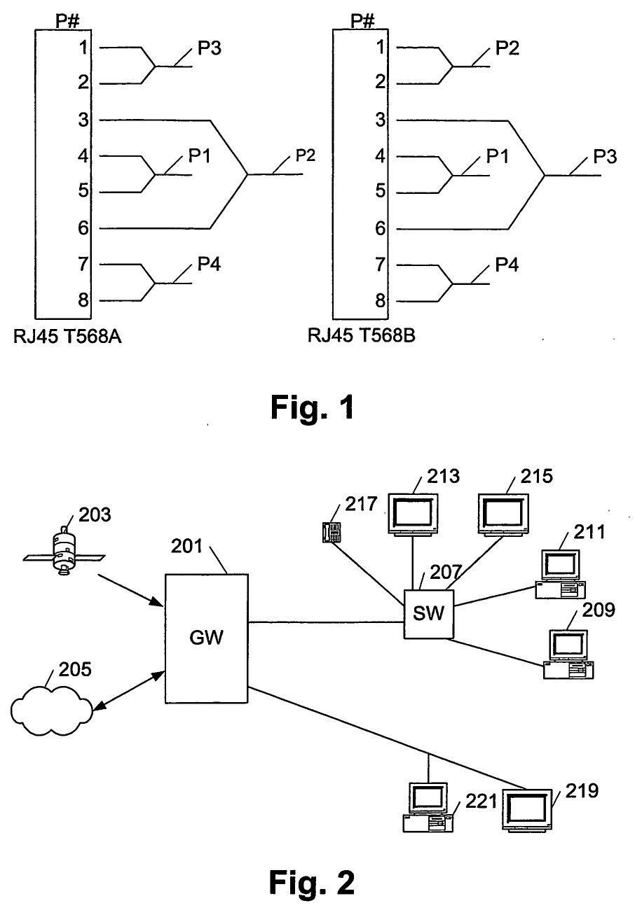

FIG. 1 illustrates the pins in two types of an RJ45 jack,

FIG. 2 illustrates an Ethernet network according to the present invention being used for distributing non-IP signals IP signals,

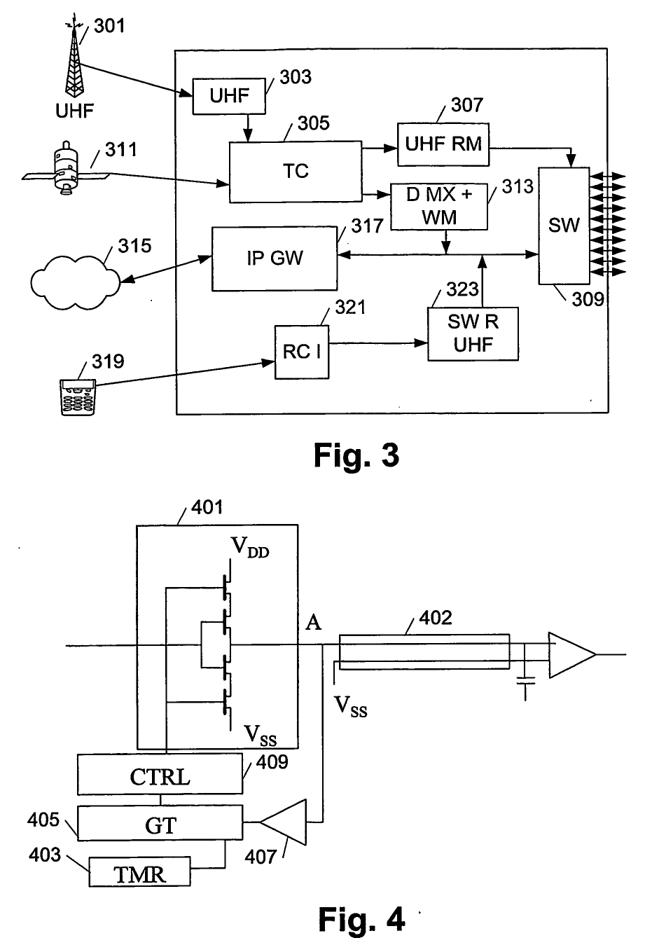

FIG. 3 illustrates the architecture of a gateway to be used for processing the signals and distributing them to devices via the Ethernet based network according to the present invention, a

FIG. 4 illustrates impedance adaptation of the UTP cabling in the signal path of the Ethernet network for distributing non-IP signals.

Building regulations in Europe and the USA, plus the building equipment supply and installation industry have a strong bias towards the IEEE standard 802.3 and EIA/TIA 568. Other digital network standards are either not suitable for building installation or unapproved at USA or European level. Moreover, because the standard is widely employed in offices, the installation industry is skilled in the installation process of Ethernet. It has also been stated recently that all new domestic or office buildings in France must be wired with UTP Category 5 or better signal quality cabling.

The widely adopted standard for electrical wired Ethernet there is referred to as 100 Base-TX. For media cabling this standard employs Category 5 wiring, four sets of 100 Ohm unshielded twisted pairs or UTP, in maximum segments of 100 meters in star topologies.

In FIG. 1 the connectors for this physical layer being RJ-45 connectors are illustrated. The RJ45 connectors have 8 contactors, one for each conductor of the 4 twisted pairs. There are two wiring patterns for the RJ45, these are referred to as EIA/TIA 568A and EIA/TIA 568B, where the later B variant is the most recent and more commonly used. Both variants use two of the twisted pairs, in fact, the same contactors on the connectors, but using different wiring color schemes for connections. A RJ45 connector can be used in conjunction with the RJ11 connector with four pins (Telephone connector), and under AT&T wiring schemes the RJ11 plug can be used with a double RJ45 socket to carry telephone and Ethernet over the same cabling. In fact the RJ11 plug can always physically be plugged into the RJ45 socket. And the “typical” double RJ45 socket arrangement allows a computer and/or a telephone to access the same wiring using combinations of RJ45/RJ11 plugs.

This 100 Base-TX wiring scheme leaves half of the RJ45 connectors, i.e. twist pairs on pins 4, 5, and 7, 8, wired, but unused by the physical protocol of Ethernet, and thus redundant in most office and home wiring schemes i.e. those not using the RJ11 arrangement, while most Ethernet routers, switches and hubs use only the 100 Base-TX wiring connections. In the USA this “redundancy” is used to carry voice circuit on the pins 4, 5 (P1) to RJ11 in parallel to the RJ45, but requires a double socket arrangement and patching systems. Note: redundancy is used in other cases too, e.g. France, to wire two Ethernet connections over one cabling system, by transfer of pins 1, 2 to pins 4, 5 and pins 3, 6 to pins 7, 8 at both ends. This is found in hotels and similar public locations, where a resident's lap-top can use the normal IP double twisted pair connection at the RJ45 connector when for example an extended terminal i.e. room TV is using the alternative IP connection. Similarly, for home networking one can use the same technique to extend the use of internal wiring to provide two IP connections over one Category 5 cabling systems.

According to the present invention the redundant twist pairs of the UTP cabling are used to transfer at least high-grade non-IP analogue signals in a star network over the household.

Though in order to be able to transfer these signals a number of adaptations of the network at physical level are necessary. These modifications must be implemented at the level of the gateway, router and switching functions of the network, allowing the analogue signals to be multiplexed into the physical network. If these signals are multiplexed into the network, then terminals attached to the network can utilize the analogue signal—either directly using an RJ45 connector to the network or using an adapter, which allows the terminal to utilize these signals.

A non-exclusive list of analogue and non-IP signals that are open to such multiplexing fall into the following classes:

Broadcast TV and radio (as selected channels in a base band);

POTS Telephony as RJ11;

Broadband cable (transcoded);

USB signals.

In FIG. 2 an Ethernet network according to the present invention being used for distributing non-IP signals and IP signals is illustrated. The network comprises a gateway (GW) 201, which receives analogue non-IP signals from respectively satellite 203 being e.g. a TV signal. The gateway is further connected to the Internet 205 for receiving IP signals. The gateway is then connected to two separate Ethernet based networks being respectively a first network based on a switch (SW) 207, which handles the distribution of respectively the IP signal and the non-IP signals between different devices being computers 209, 211, televisions 213, 215 and an IP based phone 217. Further, the gateway 201 is directly connected to devices being respectively a television 219 and a computer 221.

Classical Ethernet gateways, hubs, routers and switches are not suitable to create UTP networks to carry analogue signal on the redundant twisted pairs of UTP cabling without modification or adapters. The adaptation of the network further requires multiplexing of signals from internal or external sources.

The logical location for introduction of analogue non-IP signal into the network is at the level of gateways where different protocols are handled for the network adaptation. Analogue or non-IP signals can be introduced into the network from external sources, STB or DVD player, or by transcoding, i.e. digital to analogue conversion at the gateways from various sources.

In FIG. 3 the architecture of a gateway is illustrated. The gateway is the point where one class of non-IP signals are introduced to the network. In FIG. 3 the gateway receives input from an UHF broadcaster 301, this input is received by a UHF tuner 303. In 305 a transcoder (TC) for transcoding receives both input from the UHF broadcaster 301, but also a signal from a DVB broadcaster 311. In 307 a UHF remodulator (UHF RM) remodulates the transcoded signal, and via a switch (SW) 309 the signal is distributed via the Ethernet. The gateway further comprises a digital mixer and watermarking device (D MX+WM) 313, which is adapted for mixing local digital content with the broadcasted content and further adding watermarking to the content. The gateway further comprises the standard IP gateway (IP GW) functionality 317 for handling firewalls, NAT, DHCP, etc. Further, the gateway comprises a remote control interface 321 for receiving input from a remote control unit 319. The remote control input is in 323 used for switching the routing of the signal received from the UHF tuner 303.

By extending the capabilities of the gateway to include the capability of transcoding digital content to analogue protocols, and mixing local digital content with broadcast analogue content, the functionality of the gateway can be enhanced and the capabilities of the display clients minimized to that of a conventional analogue TV. In this scheme there is a transcoding path, which allows AV and other formatted data and streams to be reformatted to one or more analogue TV or radio channels, which can then be reproduced and recorded using conventional AV techniques. Such transcoding includes the addition of watermarks and similar security devices to ensure that analogue content can be traced to original digital transmission sources and paths.

Switches or the switch functionally in Routers and Gateways provide the basic signal switching of the IP and non-IP signals. For the non-IP signals the analogue switching will have to be of a quality superior to that provided by the Category 5 cabling and related sockets and plugs. Switches are adapted to provide transmission of high quality video and analogue signals. In addition switches could be adapted for switching high performance Gigabit Ethernet signals as IP traffic if the network forms part of a Gigabit-100/10 Mbit hybrid network. Such hybrid would arise in a home network with a mix of home-office and multimedia technology, where the home-office needs Gigabit technology for the backbone IP network. However, in the living room, kitchen, bedroom, garage, etc. the Ethernet connections have to be employed to carry both the IP and non-IP signals. A second class of analogue non-IP signals can be introduced into the networks at the switches, these are the intra-network signals, which will be routed to other switches in the network or to the gateway for transcoding to IP based protocols.

Routers provide another set of services to the network. The router provides control over the internal communication of the network. It must have an IP link to the clients and servers of the network to provide these services. Such services include DHCP, i.e. providing the internal IP addressed to the network. In the present invention the Router will further have to provide a central mechanism to control and set-up the alternative non-IP network in the Category 5 cabling. The router instructs the sources and sinks of the data about the protocols used on the I/O redundant cabling, and then arranges the routing over the switches and hubs that provide the infrastructure to the networks. For the switches, the basic switching for the IP and non-IP signaling will be similar. However, a hub is a much simpler device, which works for IP networks in a fashion that will not be generally true for the broad range of protocols. Thus, a hub will either have to employ a very simple configuration for the non-IP signals, or have the full functionality of the IP switch for the non-IP signals. Control and instruction of the switches by the routers will duplicate that used for IP routing.

The impedance of the transmission medium of twisted pairs in UTP cabling is 100 ohm; this is accurately manufactured in the cable, which is necessary to allow high bandwidth transmission of data. However, the traditional medium for transmission of VHF and UHF signals is 75 ohm using co-axial and not twisted pairs. To allow the transmission of analogue data over the twisted pairs, some form of active compensation of the signal path will be required. This signal transmission path adaptation can be achieved using the technique of time-domain reflectometry. Using this technique, the signal path discontinues and end-of-line impedance mismatches (IV, connectors and adaptors) can be compensated for by the driver electronics in the gateway.

In FIG. 4 an example is illustrated of how the impedance of the cabling can be compensated by performing simple modifications of the driver 401 handling a twisted pair to be used for transmission of analogue data. The modifications enable adaptation of the signal path and comprise a timer 403 generating clock pulses, the timer 403 is connected to a gating circuit 405, the gating circuit 405 is connected to an amplifier 407, which again is connected to the input A of the cable segment 402, whereby the amplifier 407 amplifies a returned signal and forwards it to the gating circuit 405. The gating circuit 405 is connected to a control circuit 409, which controls the driver 401.

The measurement of the cable signal path characteristics is a two-step process:

1. A segment of cable 402 is isolated, i.e. terminated with high (open) impedance, and then a signal transition 0 to 1 (1 to 0) is propagated from the driver 401 at point A after a trigger has been generated.
2. The return of the signal at point A is amplified by the amplifier 407 and monitored by the modification circuit comprising the timer 403, the gating circuit 405 and the control circuit 409. Based on the monitoring of the return signal, returning signals of appropriate level terminates a gated counting process.

The gating circuit allows the trigger point to be adapted to allow one or a series of measurements be made to adapt the drivers of the transmitting signals to optimize the characteristics of all signals on the (IP and non-IP) UTP cabling segment.

This adaptation process can be iterative, or made directly by providing values from Look-up table of optimized characteristics for known signals. Adaptation of the signal strength is necessary if the cable segment is changed, or another signal type is propagated along that cable segment. This is not expected to be frequently performed at switches, so as a terminal is added to a switch. However, at a router the process could be more dynamic as the signal path use needs to be optimized for limited capacity.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for distributing both IP signals and non-IP signals in an Ethernet based network, wherein the Ethernet based network comprises UTP cabling comprising a number of wires, the method comprises distributing said non-IP signals through a signal path based on wires comprised in said cabling and not being used for distributing said IP signals.

2. A method according to claim 1, wherein an adaptation is performed on either said signal path or said non-IP signals before distributing said non-IP signals on wires comprised in said cabling.

3. A method according to claim 2, wherein an adaptation performed on said signal path comprises adapting the impedance of said signal path.

4. A method according to claim 3, wherein said adaptation is achieved by active adaptation of the signal propagation by control of driver strength.

5. A communication system for distributing both IP signals and non-IP signals in an Ethernet based network, wherein the communication system comprises UTP cabling comprising a number of wires, where the wires comprised in said cabling, which are not being used for IP signals, are adapted for distributing said non-IP signals.

6. A communication system according to claim 5, wherein said system comprises means for performing an adaptation on either said signal path or said non-IP signals before distributing said non-IP signals on wires comprised in said cabling.

7. A communication system according to claim 6, wherein said means for performing an adaptation on either said signal path or said non-IP signals comprise means for adapting the impedance of the signal path for distributing said non-IP signal.

8. A communication system according to claim 7, wherein said means for adapting the impedance of the signal path for distributing said non-IP signals comprise means for performing active adaptation of the signal propagation by control of driver strength.

9. A communication system according to claim 5, wherein the system comprises a gateway, said gateway being adapted for:
receiving non-IP signals,
performing an adaptation on either said signal path or said non-IP signals before distributing said non-IP signals on wires comprised in said cabling,
transmitting said processed non-IP signals via the Ethernet based network.

10. A communication system according to claim 5, wherein the system comprises a router, said router being adapted for routing the non-IP signals, enabling the non-IP signals to be broadcasted to all end points in the Ethernet network.

11. A communication system according to claim 5, wherein the system comprises a switch, said switch being adapted for:
transmitting said non-IP signals,
switching between said non-IP signals and said IP signals.

12. A gateway adapted to be used in a communication system according to claim 6, wherein the gateway is adapted for:
receiving non-IP signals,
performing an adaptation on either said signal path or said non-IP signals before distributing said non-IP signals on wires comprised in said cabling,
transmitting said processed non-IP signals via the Ethernet based network.

13. A router to be used in a communication system according to claim 6, said router being adapted for routing the non-IP signals enabling the IP signals to be broadcasted to all end points in the Ethernet network.

14. A switch to be used in a communication system according to claim 6, wherein said switch is adapted for:
transmitting said non-IP signals,
switching between said non-IP signals and said IP signals.
